(19) United States
(12) Patent Application Publication
(10) Pub. No.: US 2012/0072187 A1
(43) Pub. Date: Mar. 22, 2012

(54) System for evaluating energy consumption

(76) Inventors: Scott Irving, Santa Fe, NM (US); Roddy J. Gesten, Santa Fe, NM (US)

(21) Appl. No.: 12/924,108

(22) Filed: Sep. 21, 2010

(51) Int. Cl. G06G 7/62; G06F 17/10

(52) U.S. Cl. 703/2

(57) ABSTRACT

Disclosed is a computerized method which receives energy consumption data from all sources used for the operational functioning of a building, converts consumed energy to BTU form, and establishes a historical energy footprint. System compiles these records for storage in a database capable of sorting data by category and/or value and compares energy to that used by structures of similar construction type and climate zone, improved and unimproved. System and method compares cost to yield data, concluding with the most cost effective and energy efficient method of modifying structures to predictably reduce its energy footprint/consumption per the database of energy consumption patterns. The system measures structures after improvements to verify reduced energy consumption.

### BACKGROUND OF THE INVENTION

1. Field of the Invention

The present invention is a system with a method for collecting, measuring, analyzing, defining, comparing and predicting the energy consumption in built structures regardless of construction type, size, climate zone and energy source(s) by receiving and processing energy consumption and field survey data, including calculating and recording the heated square footage and area of building envelope of the structure(s) under study, for purposes of reducing the structure's energy consumption.

2. Description of the Prior Art

According to Architecture 2030, Building Sector: A hidden culprit, “data from the US Energy Information Administration illustrates that buildings are responsible for almost half (48%) of all energy consumption and GHG emissions annually; globally the percentage is even greater. Seventy-six percent (76%) of all power plant-generated electricity is used just to operate buildings. Clearly, immediate action in the Building Sector is essential if we are to avoid hazardous climate change.”

Commercial and residential buildings consume about one-third of the world's energy. The U.S., alone, has more than 130 million existing homes consuming energy in various forms. If current building energy usage trends continue, by the 2025, buildings worldwide will be the largest consumers of global energy.

A dialog concerning the limitations of the evaluation platforms we use nationwide to establish a building's energy efficiency/environmental responsibility is overdue. The United States Department of Energy recognizes this and is advocating for a national “energy based” platform. Too many of the platforms that are currently used to establish a building's environmental sensitivity and energy efficiency have been selected for use because 1) users have a history and are familiar with them or, 2) the system's developers, who have become salesmen for their respective systems have a bias toward continued use, 3) the systems' developers have a financial interest in their continued use, and are excellent lobbyists/advocates for their product, and 4) the company now advocating for the system has become an economic powerhouse with the political clout to push their product in the marketplace. None of these is a justifiable rationale for the selection of one platform of analysis over another and none of the existing platforms place an adequate emphasis on energy consumption when addressing existing buildings.

To date over 90 distinctly different, green building codes have been adopted in North America. Each code promotes a unique system of green building analysis (primarily of new buildings), which requires the use of a single modified energy analysis platform or another for its jurisdiction. The result is a confusing maze of half-formed and partially integrated policies and processes. Our nation must have one system to enable us to project, monitor, and control the energy consumption of our massive stock of existing buildings.

Although it is appropriate for regional, local (and ultimately a national) green building code for new construction, to include consideration of, design, engineering, site work, orientation, thermal storage, natural-lighting, quality of insulation, water use and disposal, mechanical and electrical equipment and distribution, interior air quality, renewable energy systems, landscaping and irrigation, effect on the local environment, many of these categories prove to be irrelevant in the analysis of existing buildings. The inability of existing platforms to evaluate, let alone analyze and predict the value of energy consumption reduction alternatives in existing construction without extensive/expensive demolition and/or testing is a disconnect from reality. These platforms lose focus and should be scrapped when it comes to the analysis and improvement of existing buildings. The method we use to analyze, predict, and then measure energy consumption in existing structures must be based on objective science if it to be of long term value.

Increasing the energy efficiency of the planet's existing homes is a more significant goal than the efficiency of new construction. We can build new, net-zero energy structures until the “cows come home”, but we will not significantly decrease our nation's and the world's energy consumption until we make the existing buildings on the planet less energy consumptive.

Environmental responsibility is an aspect of life that Americans are increasingly interested in. Understanding the energy footprint of the buildings we live and work in can provide Americans a meaningful, individual point of responsibility beyond the MPG of the cars we drive. The advent of energy analysis for permitting, rebates, tax credits, etc. has created an awareness and opportunity to establish a unit of measurement defining the “MPG” of how we live.

Today's energy related programs and systems are only marginally effective, at best, in reducing fuel consumption for the supply of energy in buildings. Worse, current energy measurement systems do not focus on existing building, but instead are built around permitting and mandates for new building design and construction. What's more, systems are difficult to understand and do not provide straightforward and reliable information.

As future legislation will likely mandate reductions in actual energy consumed over targeted time periods, along with energy labeling of existing buildings, it will become increasingly necessary to focus exclusively on energy reduction instead of a blended energy rating that takes into account a broad range of “green” factors such as air quality, off-gassing, re-use of materials and so on. This has produced gaps that exist in understanding and measuring the relative and actual impacts of a broad range of energy related improvements.

Energy usage information should be available down to its basics and applied to buildings of all types, including commercial, institutional and government. Further, the premise of investing in retrofits should reach beyond retrofit incentive programs and tax credits which all eventually end, thereby screaming for a system that provides data from which regional return on investment numbers can be derived by owners and stewards of building and perpetuating the real goal of lowering energy consumption at a reasonable cost.

U.S. Patent Application Publications numbered 20070152128, 20060224358, and 20070179034 and U.S. Pat. No. 7,389,157 describe a methodology that verifies residential compliance with the D.O.E. Energy Star Program, energy building codes and other energy rating programs such as Build America's and LEED certification. An information handling system receives data input using blower door tests investigate possible leakage in ducts and openings around the perimeter of structures. The reports that are generated go into a database that includes the results of testing, type of inspections, equipment serial numbers, and invoicing information. This system is limited to making prescriptive recommendations based on compliance requirements for a single use of structure: residential. It does not use historic consumption data to establish a baseline in order to ascertain results after a period of time. Further, the ambiguous rating derived from these tests is based on compensating factors that do not address the central issue: lowering energy consumption.

Applying the points-based platforms currently in wide use (RESNET, Energy 100, etc), which grant points for successfully achieving green construction goals, can become a numbers game, reflective of “liberal” or “conservative” accounting principles. This fact cannot be eliminated, by making the judge and jury on the successful achievement of environmental goals a “neutral third party”. These platforms add a horizontal level of ‘Energy Rater’ in the design, permitting, and construction process. Energy Raters are frequently not familiar, or in rhythm with the design/construction processes. This drives up costs to consumers, and creates another layer of bureaucracy which is susceptible to influence peddling and meddling from powerful individuals, and both consumer and governmental groups. By using these popular points-based platforms it is possible to achieve green construction targets for tax credits without increasing the efficiency and comfort, or decreasing a building's energy footprint, by using technology exigent to the building. The current programs used to rate energy efficiency in existing structures introduce the possibility of corruption, inaccuracy, and inefficiency.

Even worse, using our existing process, after granting tax credits for environmentally responsible design and construction, we don't return to verify the predicted energy consumption/efficiency of the project. In the meantime, the first owner and/or contractor of a “green certified” building can pocket their credits and move on to the next project. This is not the best method of improving the environmental responsibility of new construction. It is certainly not the best method of approaching the prediction and measurement of energy reducing improvements in the remodeling of existing structures.

U.S. Pat. No. 7,243,044 describes a method that benchmarks energy performance, using data from utility companies to prove historical use. The system uses observations derived from seasonal use, sorts information and analysis by construction type, sums and divides energy usage into electrical and fuels categories, inputs weather data for heating and cooling degree days and uses a consumption exchange rate based on BTUs/Square Foot/Hour. This system depends on a large database to derive accurate information but is limited to determining a best thermodynamic breakeven point for heating and cooling in buildings. It does not isolate and recommend building changes or modifications proven to be effective through their database. While comparative studies are made between buildings, this system appears to be merely informational in establishing a temperature for optimal performance in heating and cooling mechanical systems. Further, when considering the energy footprint of a structure, it is of ultimate importance to understand how the interaction of location, siting, and configuration affect energy consumption performance. This method uses the “degree-day” system to equate the performance of buildings in different climate zones. The “degree-day” system masks the “energy choices” inherent in choosing one geographic location over another for any structure, distorting performance in a mistaken attempt to mitigate the effects and reality of climate zones. The HEC system will ultimately, objectively, calculate which areas of the earth and climate zones can be inhabited with the smallest energy footprint and environmental cost. When developing a structure in a specific location, the HEC System can depict the orientation and plan configuration that has historically performed the best in the specific climate zone.

U.S. Patent Application 20090210192 describes a system of using thermal aerial and ground based imaging to assess the efficiency of buildings in certain locations to establish a baseline of buildings in a study area. It is purported to be a comparison of efficient to less efficient thermal characteristics using a plurality of buildings in a concentrated area. While a study such as this could be useful in identifying problems on a macro level, it should be linked to ground based measurements instrumental in a comparative analysis of all buildings of all types in a specific area or climate zone. In this way, there is precise information to measure, compare and analyze actual energy consumed over a statistically valid period of time in order to determine energy savings associated with building and structural modifications and retrofits.

### SUMMARY OF THE INVENTION

A dialog concerning the limitations of the evaluation platforms we use nationwide to establish a building's energy efficiency/environmental responsibility is overdue. Over 90 distinctly different, green building codes have been adopted in North America. Each code promotes a unique system of green building analysis (primarily of new buildings), which requires the use of a single modified energy analysis platform or another for its jurisdiction. The result is a confusing maze of half-formed and partially integrated policies and processes. Our nation must have one system to enable us to project, monitor, and control the energy consumption of our massive stock of existing buildings. The inability of existing platforms to evaluate, let alone analyze and predict the value of energy consumption reduction alternatives in existing construction without extensive/expensive demolition and/or testing is a disconnect from reality. These platforms lose focus and should be scrapped when it comes to the analysis and improvement of existing buildings. The method we use to analyze, predict, and then measure energy consumption in existing structures must be based on objective science if it to be of long term value.

The present invention is a system with a method that is used for collecting, measuring, analyzing, defining, comparing and predicting the energy consumption in built structures regardless of construction type, size, climate zone and energy source(s) by receiving and processing energy consumption and field survey data, including calculating and recording the heated square footage and area of building envelope of the structure(s) under study, for purposes of reducing the structure's energy consumption. This computerized system analyzes historical energy consumption to derive historical consumption patterns, compares those patterns to the structure's annual consumption and the annual consumption and consumption patterns of structures of like characteristics. Further, the system determines areas where the energy consumption of the structure can be reduced, determines the percentage change in energy consumption anticipated due to specific improvements to the structure and calculates their cost-to-value. Further, allows for specification by the user of energy consumption reduction target and recommends most cost effective way of achieving this goal. Further, verifies energy consumption changes due to the modification and/or addition to a structure. This computerized system uses multiple, remote information handling systems for receiving inspection data which is exported to a network comprising a central processing unit, an information storage device, and an interactive database. It then calculates, analyzes, compares, and archives the data collected in a Historical Energy Consumption Database at which time the collected data is analyzed by the primary information handling system and makes recommendations to decrease the energy consumption of the structure, reporting them back to the remote information handling system. In the best mode contemplated by the inventors, the circular logic used by the Server I.H.S. and the HEC database allows for the continual evolution of the server and database into a form of artificial intelligence.

It is therefore a primary object of the present invention to provide an objective science-based energy rating system, based on common units of measure, that establishes an easily intelligible mpg of structure's energy performance, delivering a metric and method that can be easily adopted by States and Local governments, is comparable across structures and bridges the gap between modeled and actual energy consumption.

It is another object of the present invention to identify energy performance gaps based on scientific comparison of energy consumption patterns of similar structures.

It is a further object of the present invention to recommend modifications with greatest probability of significant energy reduction in the subject structure, through scientific and statistical modeling versus implying and assuming consumption results, by taking an approach that a large test database can facilitate the modeling required to determine the efficiency and cost effectiveness of changes and investment payback periods with or without the assistance of rebates, tax credits and supplemental government programs.

It is another object of the present invention to minimize inconsistencies in the data collection process by using a formulaic approach, thus negating inexperience in construction or engineering knowledge of a rating provider.

It is a further object of the present invention to set a venue for reevaluation of energy consumption post modification implementation to confirm the energy consumption effects of recommended changes in buildings and building user habits and/or to incorporate findings into the HEC System in order to continually improve the methodology and refine the interactive HEC Database.

It is still another object of the present invention to identify construction defects, inefficient equipment, and underperforming methods without the use of expensive specialized equipment.

It is a further object of the present invention to assist planners, architects, engineers, builders, real estate professionals, energy raters, users, stewards and owners of existing and new buildings to understand the energy performance of structures and apply techniques learned from the use of the HEC System to predict energy consumption prior to undertaking design or construction projects.

It is a further object of the present invention to provide recommendations that motivate investment in existing structures as a better option to undertaking new construction.

These and other objects of the present invention will become apparent to those skilled in this art upon reading the accompanying description, drawings, and claims set forth herein.

### BRIEF DESCRIPTION OF THE DRAWINGS

FIG. 1 is the Methodology for HEC Calculations showing the logic flow diagram and benchmarking methodology in accordance with the best mode contemplated by the inventors.

FIG. 2 is a flow diagram of the computerized system to be utilized with the HEC

System.

FIG. 3 is a flow diagram depicting the collection of Historical Energy Consumption data from energy providers.

FIG. 4 depicts the process of acquiring historical energy consumption data from other energy sources.

FIG. 5 depicts the information gathering process completed prior to the performance of a HEC analysis.

FIG. 6 depicts a “What's Your HEC?” information sheet, which records and reports information gathered during the data collection process.

FIG. 7 depicts the gathering of information by remote information handling system, delivery of this information to a network which includes a server I.H.S. and database, generation of the HEC Report Card and Evaluation and delivery of this report to various entities.

FIG. 8 depicts the HEC Report Card and Evaluation which documents the findings and recommendations of the HEC analysis.

FIG. 9 is a Historical Energy Consumption Survey depicting the aggregation of BTUs from different fuel sources and calculation of the HEC-SF and HEC-BE variables, documenting multiple years of a structure's HEC-SF and HEC-BE performance, depicting changes in the HEC-SF and HEC-BE variable due to specific modifications to the structure and displaying the effects of a change in fuel sources.

FIG. 10 depicts a comparison of three structures with identical heated square footage, equipment, and climate zone, with three different building envelopes.

FIG. 11 is unused.

FIG. 12 depicts an abbreviated Historical Energy Consumption Survey calculating only the HEC-SF variable.

FIG. 13 is unused.

FIG. 14 depicts a plurality of energy meters serving a lesser number of structures.

FIG. 15 depicts a plurality of structures served by one energy meter.

FIG. 16-19 are unused.

FIG. 20 depicts how data is fractured by the Server I.H.S. and stored in the database to allow for the study of various characteristics of a structure's energy consumption.

FIG. 21 demonstrates HEC Database Processing for the HEC Report Card and Evaluation, and the circular logic that allows for intelligent evolution in the HEC server and database.

FIG. 22 depicts the HEC Verification Report which documents energy consumption changes due to modifications made to any structure with an existing HEC.

FIG. 23 depicts how the HEC database processes and stores data in the component library of the HEC Database.

### DETAILED DESCRIPTION OF THE INVENTION

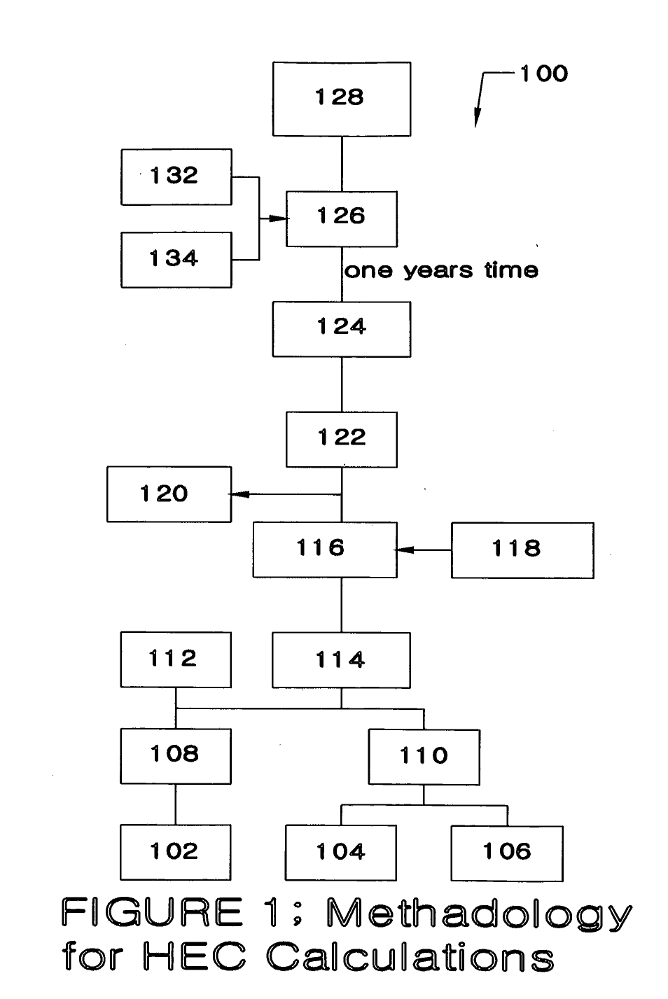

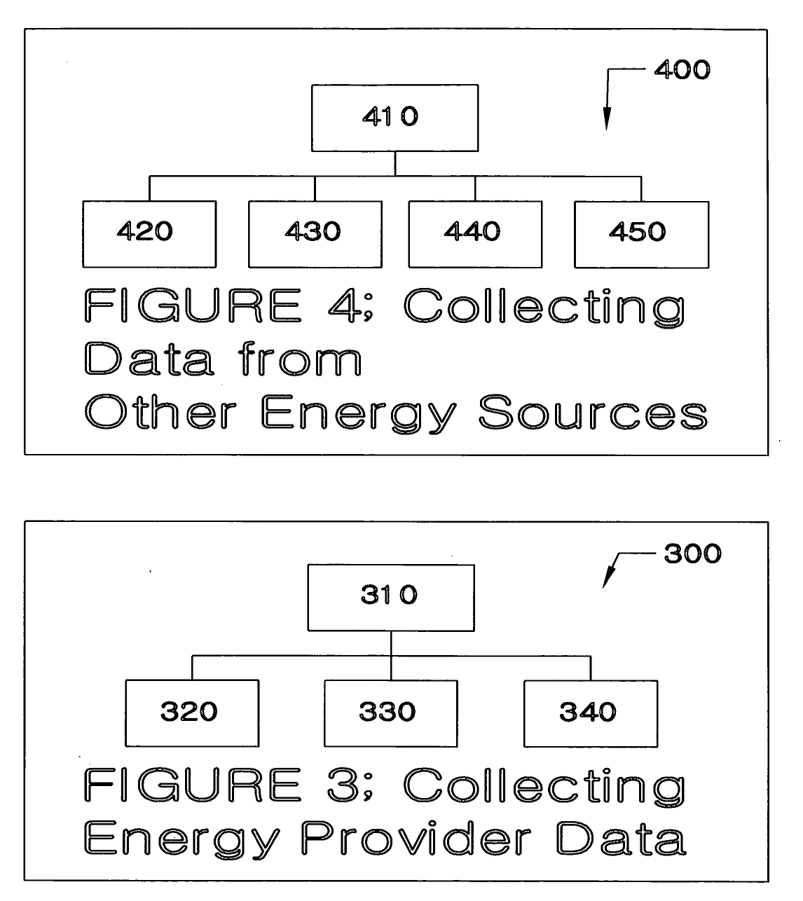

Turning now to the drawings, FIG. 1 shows a method 100 for establishing the baseline energy consumption of a structure in accordance with the best mode contemplated by the inventors. Method 100 begins with steps 104 & 106, comprising the collection of data defining a structure's historical energy consumption, as supplied by energy providers and consumers. For example step 104 and FIG. 3, Method 300, involves the collection of two to five years of energy bills, step 106 & FIG. 4, Method 400, involves the collection of 2-5 years of energy consumption data from other sources. Steps 104 & 106 can be completed by obtaining hard copies of invoices from the owners of the subject structures or from energy providers. Alternatively the data could be collected electronically from any of these sources in any combination or by directly monitoring energy meters at the subject structure(s).

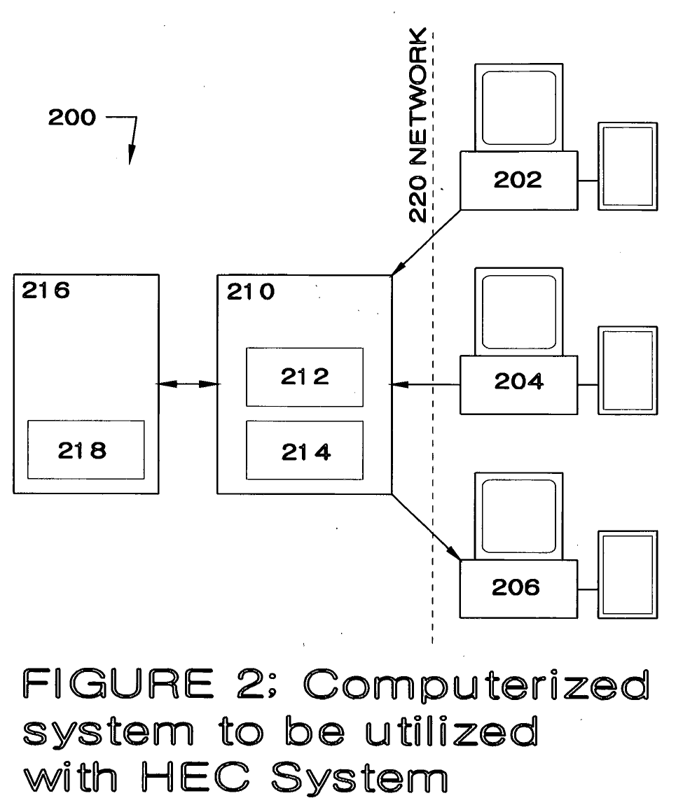

In the best mode contemplated by the inventors, when paper invoices are collected in FIG. 1 steps 104 & 106, they are scanned (unless obtained electronically) using scanners attached to remote I.H.S.'s 202, 204 & 206, see FIG. 2 System 200 and archived in database 216.

In FIG. 1 Step 110, the total energy consumed for a structure's operation must be aggregated in common units. The universally accepted method of describing heat transfer is in British Thermal Units (BTU's) per square foot per hour. In FIG. 1 step 110, all energy consumed by the building is converted to BTU's/square foot/hour. The conversion to and calculation of BTU's/SF/HR is accomplished by remote I.H.S.'s 202, 204 & 206 in FIG. 2 System 200, using Method 900 Steps 906 & 908.

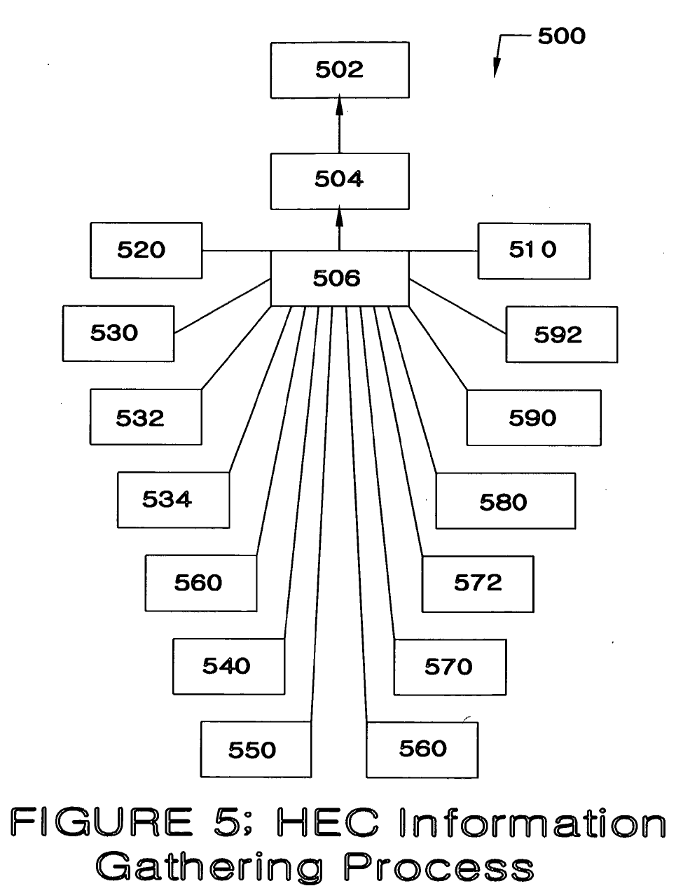

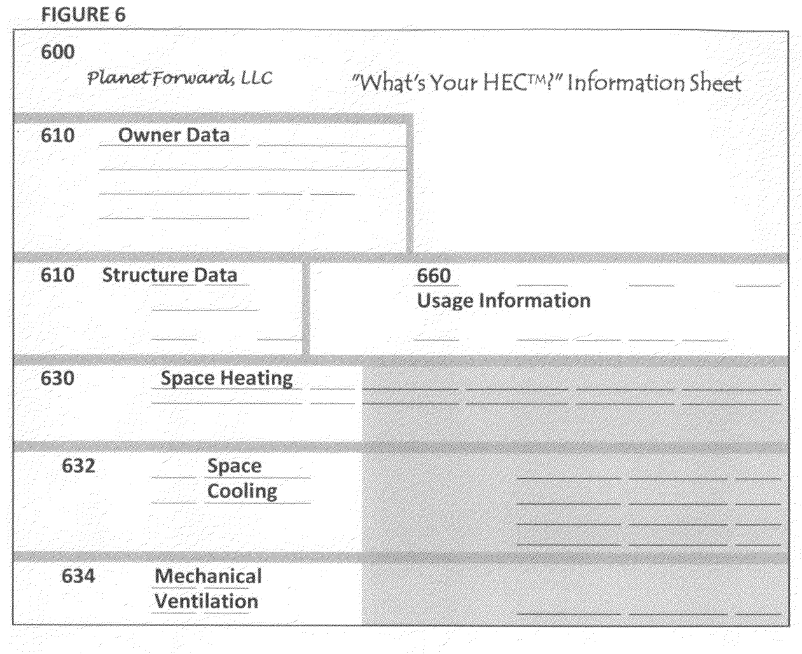

In step 102, simultaneous to steps 104 & 106, field inspection data is collected as shown in FIG. 5 and organized as shown in FIG. 6, the “What's Your HEC” Information Sheet. In FIG. 1 step 108 the heated square footage (SF) and the area of the building envelope (BE) are calculated using data acquired during the field inspection, step 102. Heated building square footage and the heated building envelope are calculated, using I.H.S.'s 202, 204 & 206. See FIG. 2 System 200. Heated building square footage is defined as the heated two-dimensional area fully enclosed by wall construction, including the area of the walls themselves. The building envelope area is calculated by summing: the total area of the exterior walls from the top of the lowest floor subfloor to the intersection of these surfaces with the exterior roofing material and, the total area of the exterior roofing surface within the perimeter of the exterior walls.

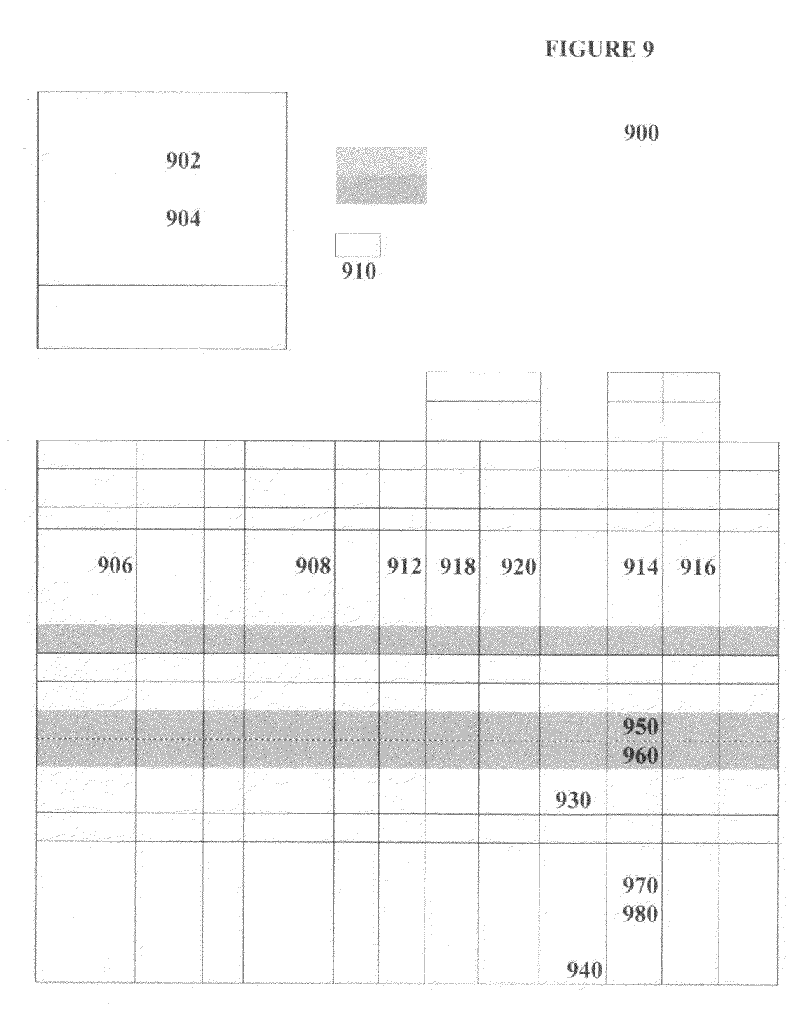

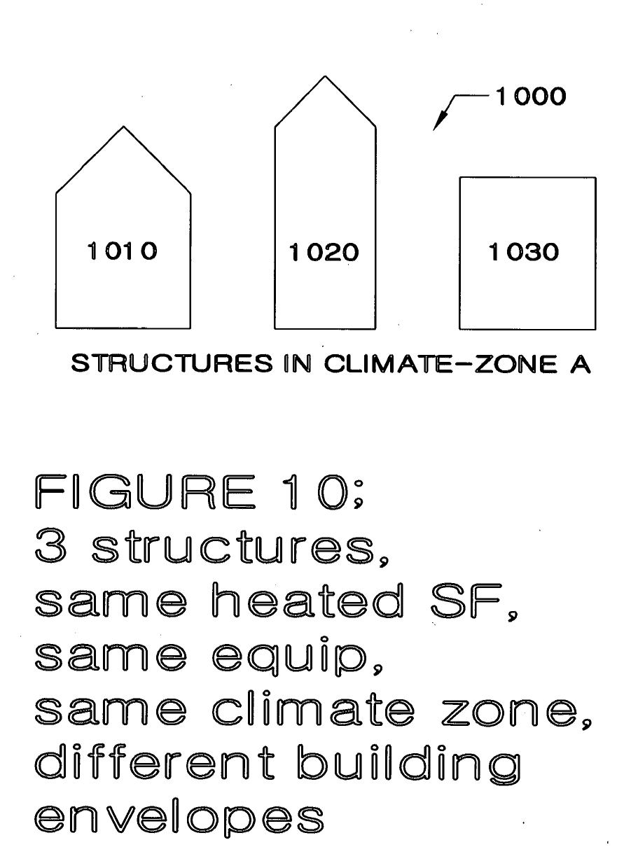

In the best mode contemplated by the inventors, a Method 900 of using the ratio of the BE Step 904 over the SF Step 902 (BE/SF) is used to compare the energy consumption of structures with similar heated square footage and construction type of varying volume, see FIG. 9 Method 900 Step 910. This allows for the consideration, by experts in the art, of the energy consumption repercussions of structures with multiple floor levels and varying ceiling geometries and heights. See FIG. 10 Structures 1010, 1012 & 1014.

We now calculate HEC-SF, Steps 914 & 916, and HEC-BE, Steps 918 & 920. To calculate HEC-SF, divide the total BTU content of fuels consumed and summed in FIG. 9 Method 900 Column 912 by the heated square footage in FIG. 9 Step 902. Then, divide the result by 8760, the number of hours in a year. This calculation yields the HEC-SF variable, defining the building's Historical Energy Consumption (HEC) in BTU's/SF/HR by month per FIG. 9 Method 900 Column 914 and by year in Column 916.

To calculate HEC-BE, Steps 918 & 920, divide the total BTU content of fuels consumed and summed in FIG. 9 Method 900 Column 912 by the square footage of the heated building envelope in FIG. 9 Step 904. Divide the result by 8760 (the number of hours in a year). This calculation yields the HEC-BE variable, defining the building's Historic Energy Consumption (HEC) in BTU's/SF Heated Building Envelope/Hour, by month (Column 918) and by year (Column 920).

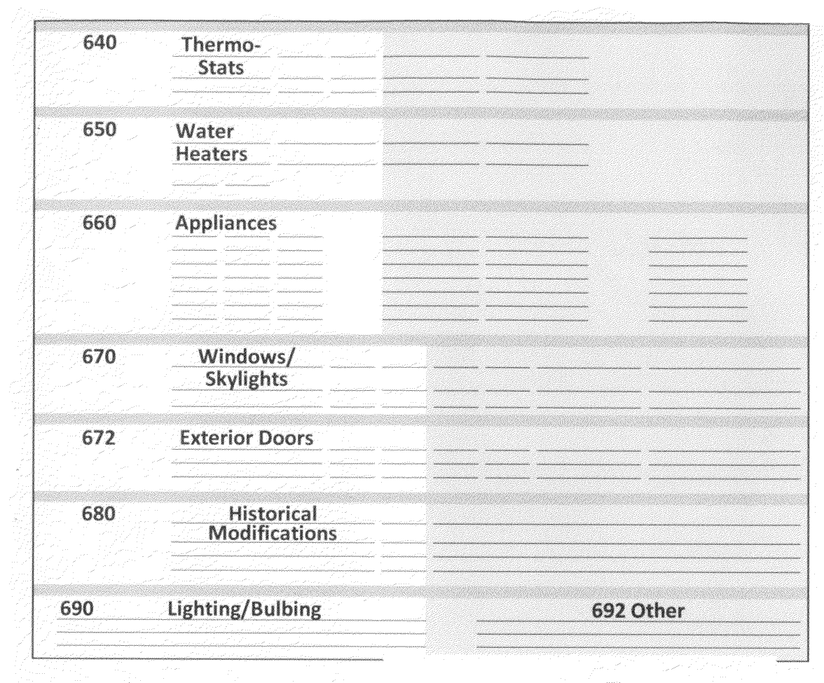

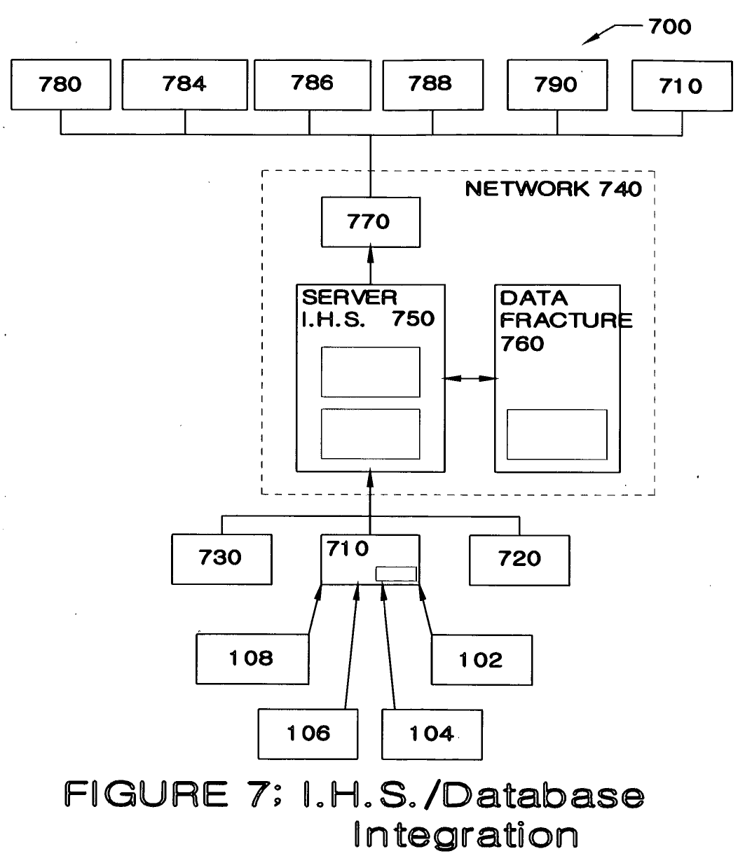

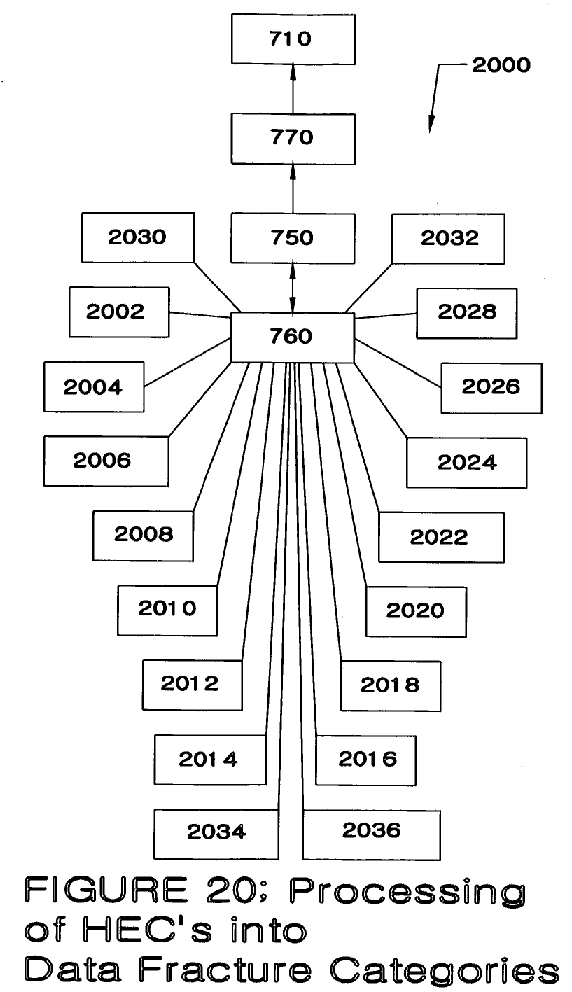

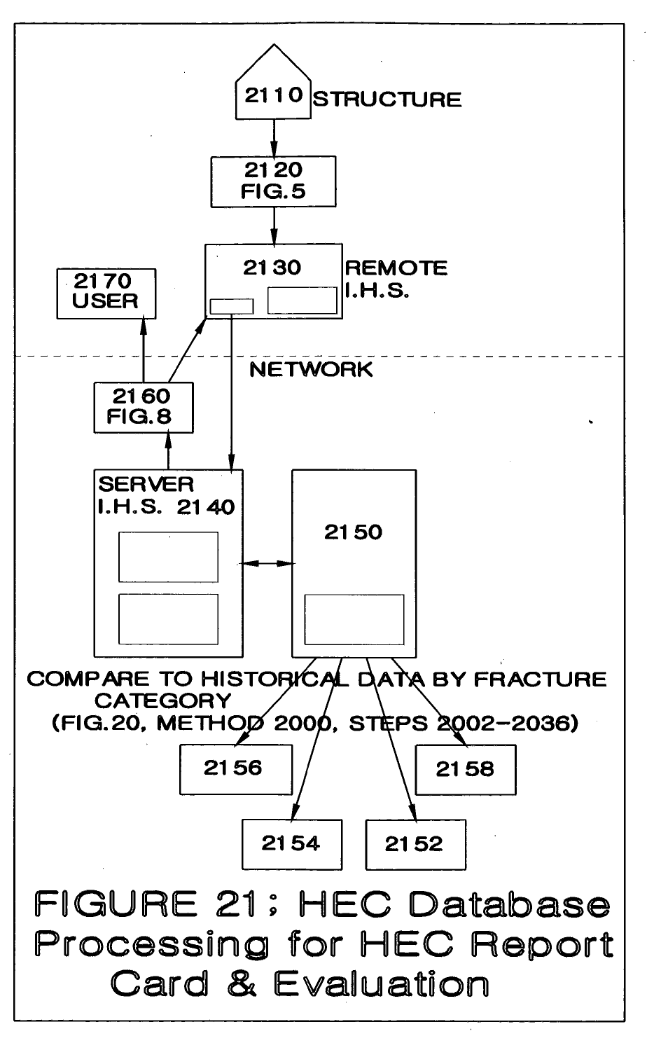

Upon conclusion of the HEC calculations by remote I.H.S.'s per FIG. 2 Method 200, information is sent via the internet to network 220 and is processed by server I.H.S. 210. FIG. 7 shows Method 700 whereby the I.H.S. server takes information received from remote I.H.S.'s 710, 720 & 730 and uses control files FIG. 2 Item 214 to fracture data from remote I.H.S.'s for storage and compilation in an interactive Database 760. Data compiled and transmitted to Database 760 is fractured per FIG. 20 Method 2000 and stored in Database 760. Data is fractured into categories per FIG. 20 Method 2000 Steps 2002-2036, notwithstanding the inclusion of further future steps.

FIG. 20 Method 2000 describes the HEC System data fracture process. Server I.H.S. 750 receives all HEC Surveys from remote I.H.S.'s. HEC Surveys received by I.H.S. 750 are compiled and stored in HEC-Database 760. Fracture of data into characteristics (Steps 2002-2036) is performed by Server I.H.S. 750 in an interactive process with Database 760. Internal algorithms allow Server I.H.S. 750 to recognize and partition energy consumption by characteristics, see Steps 2002-2036.

After all energy used by a structure is aggregated per FIG. 1 Method 100 Step 110, Server I.H.S. 220 may be used to observe energy consumption patterns and compare to the data stored in HEC Database per Step 116 of how energy is being used in the structure. For example, electrical use may be seen to rise in the summer but remain relatively constant in the winter. Similarly, natural gas use may be seen to remain relatively constant in the summer and increase in the winter. From these types of observations, Server I.H.S. 220 can conclude the likely uses for electricity and natural gas during each time period. This decision is made by Server I.H.S. 2140 using data gleaned from HEC Database 2150 using control files 214 per FIG. 2 Method 200.

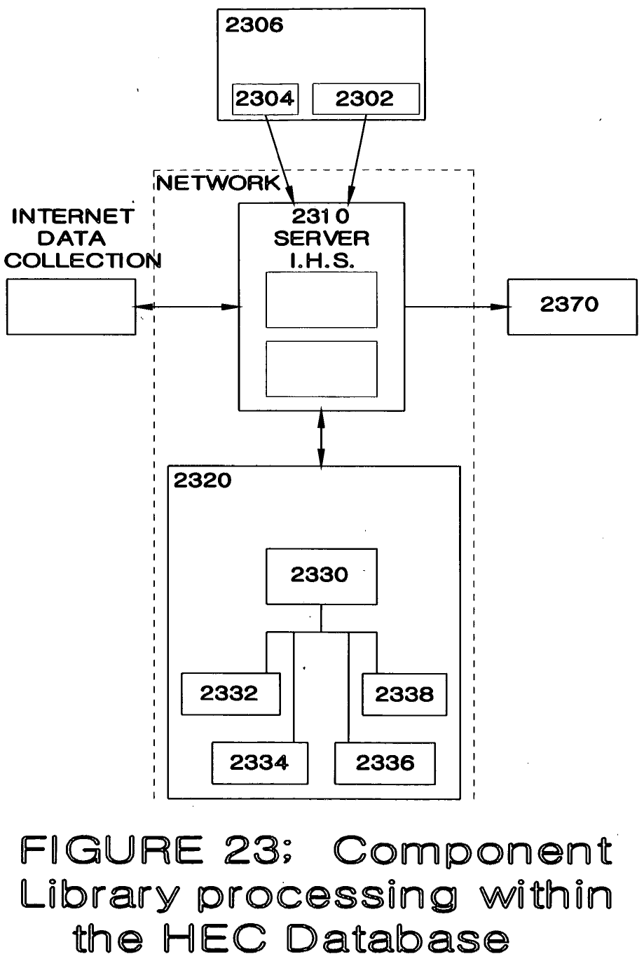

In the best mode contemplated by the inventors, Server I.H.S. per FIG. 23 Method 2300 Step 2306 takes data provided by the HEC Information Sheet (Step 2302) and draws conclusions concerning the use of energy consumed by the building. For example, electricity is being used for heating and not cooling, electricity is being used for cooling and not heating, electricity is being used for both heating and cooling, electricity is being used neither for heating nor cooling, natural gas is being used for heating and not cooling, natural gas is being used for cooling and not heating, natural gas is being used for both heating and cooling or natural gas is being used neither for heating nor cooling. These conclusions allow Server 2310; using interactive HEC Database 2320, to apportion energy consumption according to the characteristics described in the 2302 HEC Information Sheet for which whose data is archived in the 2330 component library and is assembled in report form on the 2370 HEC Report Card & Evaluation. Further, in FIG. 1 Method 100 Step 110, the aggregation of energy consumption data shall be performed by calendar month and year. Since invoices are not always sent by calendar month, it may be necessary to prorate (e.g. using linear interpolation) to adjust the aggregated use data so that the numbers being aggregated provide a good representation of the actual energy consumed for the calendar month.

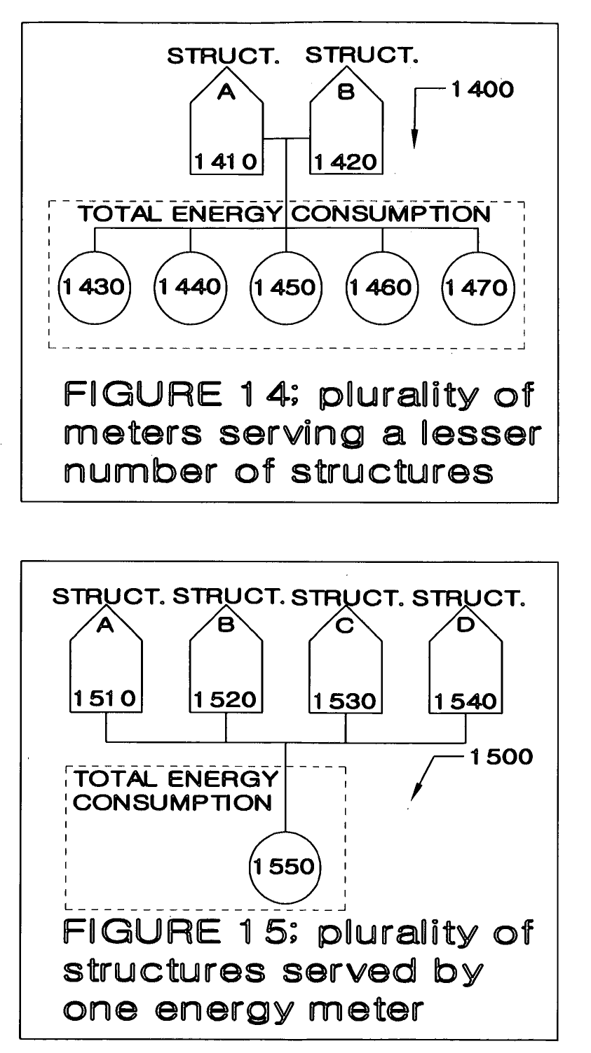

FIG. 14 Method 1400 depicts the HEC System calculating the energy consumption of one or more structures served by a plurality of meters, per Steps 1430-1460. When this condition exists, the HEC System, per FIG. 23 Method 2300 uses Server I.H.S 2310, HEC Database 2320, and the HEC Database component library 2330 to apportion energy consumption in each structure (See Steps 1410 & 1420).

FIG. 15 Method 1500 depicts the HEC System calculating the energy consumption of one or more structures served by one meter, per Step 1550. When this condition exists, the HEC System, per FIG. 23 Method 2300 uses Server I.H.S 2310, HEC Database 2320, and the HEC Database component library 2330 to apportion energy consumption, in each structure (See Steps 1510-1540).

In the best mode contemplated by the inventors, FIG. 20 Method 2000 portrays the storage of all HEC surveys, per FIG. 9 Method 900 in interactive Database 760. Steps 2002-2036 depict the storage of data by category within Database 760. The HEC system recognizes that all possible changes that can be made directly to a structure can change that structure's energy consumption patterns. When a specific modification changes the energy consumption patterns of a structure, the HEC system database (Item 760 per FIG. 20 Method 2000) will record the energy consumption effects of the change by specific category, see Steps 2000-2036. As additional HEC surveys are stored in the Item 760 HEC database the pattern of energy consumption effects due to specific building modifications is refined by category, see Steps 2000-2036. As the HEC database expands, multiple examples of the breadth of changes possible (per Steps 2000-2036) and the resultant effect on energy consumption accumulate by data fracture category. The record of a specific modification's effects on energy consumption is compiled by and stored in the HEC database (per FIG. 20 Method 2000) and establishes a statistical record on which the probability of the effects of the change can be predicted.

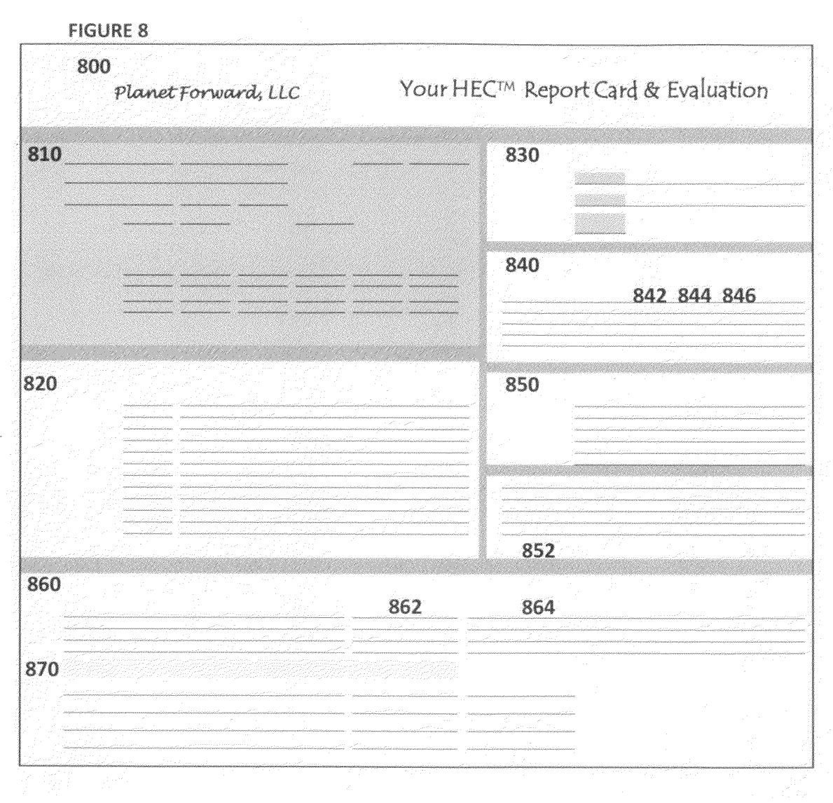

In the best mode contemplated by the inventors, FIG. 21 Method 2100 illustrates how the HEC Survey data (per FIG. 9 Method 900) is processed from data entry through the HEC Report Card and Evaluation, see FIG. 8 Method 800. Furthermore, FIG. 21 illustrates as an example of how one item can establish a historical record of energy consumption changes associated with specific modifications, how records are fractured by all modes listed in FIG. 20 Method 2000 Steps 2002-2036 and how these records are used as a predictive tool for assessing energy responses to contemplated modifications to a structure.

In the best mode contemplated by the inventors, the circular logic expressed in FIG. 21 Method 2100 and used in calculating the statistical range of anticipated effects allows for an artificially intelligent growth in the database. A structure is studied and its characteristics are recorded and reports prepared per Steps 2120 & 2130. The structure's specific characteristics are reported to the Server I.H.S. 2140 and sent to HEC Database 2150 for fracture. A HEC Report Card is generated by Server I.H.S. 2140. The Report Card is recorded in HEC Database 2150 and fractured per FIG. 20 Method 2000 Steps 2002-2036 and stored in HEC Database 2150 for future analyses. The Server I.H.S. 2140 compares the specific characteristics of the structure being studied to structures of comparable characteristics per FIG. 20 Method 2000 Steps 2002-2036 stored in HEC Database 2150. The Server I.H.S. 2140 prepares the HEC Report Card & Evaluation, FIG. 8 Method 800 using the results of the analysis of database records. The HEC Report Card 2160 is sent by Server I.H.S. 2150 to Remote I.H.S. 2130 that sent the original HEC Survey FIG. 9 Method 900 concerning the structure to the Server I.H.S. 2130, and to the User 170.

In the best mode contemplated by the inventors, the HEC Report Card & Evaluation FIG. 8 Method 800 restates the information collected during the compilation of the HEC Information Sheet, see Method 800 Step 810. Then, it provides an evaluation per Step 820 describing the general quality of a selected group of characteristics relative to the quality expected in a structure of comparable characteristics. The HEC Report Card & Evaluation Step 830 reports: historical HEC-SF and HEC-BE annual variables as calculated for up to five (5) consecutive years and reports current calculated BE/SF ratio. In the event that a structure has been studied using the HEC System, both before and after modifications are incorporated, the effects of those changes on energy consumption are recorded in Step 840.

Step 840 reports the effects of the incorporated changes by stating the 840 pre-change and 844 post-change calculated HEC-SF variables. The change is also reported as an 846 percentage change from the Pre-Mod HEC-SF. Specific changes made and the date of their incorporation are reported in Step 840 also. Step 850 uses data compiled by the HEC database to document the heated square footage, area of the heated building envelope and BE/SF ratio, HEC-SF variable, and HEC-BE variable of three structures selected by Server I.H.S. 2140 from the 2150 Database with the greatest number comparable data fracture characteristics per FIG. 20 Method 2000 Steps 2002-2036. Step 852 allows for short statements examining HEC rating comparisons with the 850 documented comps.

In the best mode contemplated by the inventors, changes, modifications, additions made to a structure with a calculated HEC-SF & HEC-BE are tracked for analysis of their effect on energy consumption after their inclusion in the structure. FIG. 20 Method 2000 illustrates how data is fractured by Server I.H.S. 750 for storage in Database 760, which allows for database searches by characteristic to achieve energy consumption goals. FIG. 1 Method 100 Step 118 depicts that modifications and alterations may be selected based on energy consumption reduction and cost to yield goals established by stewards of the building. Step 116 depicts the searching of Database 760 per Method 2000 FIG. 20 for use in determining what modifications, changes and additions will provide the greatest potential for reduction of energy consumption for the least monetary cost. FIG. 8 Method 800 Step 860 lists the most effective specific modifications selected by Server I.H.S. 2140 that can be made to the subject structure to reduce its historical energy consumption. Step 862 lists separately the anticipated cost range of each recommended modification and Step 864 its anticipated energy savings.

Further, in the best mode contemplated by the inventors, information collected with the “What's Your HEC Information Sheet”, FIG. 6 Method 600, allows for detailed analysis of structures with similar characteristics. Steps 620-680 allow for the collection of specific data concerning space heating and cooling equipment, mechanical ventilation, thermostats installed, water heating equipment, appliances, window and exterior door types and historical modifications. Data collected on the HEC Information Sheet (Step 2302 Method 2300) is sent on per FIG. 23 Method 2300 to Server I.H.S. 2310 by Remote I.H.S. 2306. Server I.H.S. 2310 examines the data provided on HEC Information Sheet 2302 and verifies that Database 2320 contains performance data for the specific items listed in Steps 630-680 FIG. 6 in its partitioned component library 2330, Steps 2332-2338. If data is found in the 2330 component library of HEC Database 2320 for the item in question it is used by the HEC system in the creation of the 2370 HEC Report and Evaluation. If no data is found in the 2330 Component Library for the item in question, Server I.H.S. 2310 accesses the internet to collect available manufacturer's performance data for the item. Server I.H.S. 2310 takes the manufacturer's performance data, found via the internet, and compiles this data in Component Library 2330 for the needs of the current HEC Report and Evaluation and for processing with future HEC Reports and Evaluations. Component Library 2330 stores energy consumption characteristics for specific Appliances in Step 2332 and specific pieces of equipment in Step 2334. Energy consumption characteristics and ratings for windows, skylights, and exterior door types are stored in Component Library 2330, Step 2336. Component Library 2330 compiles bulb and lighting characteristics in Step 2338.

Per FIG. 23 Method 2300, after collecting and archiving in HEC Database 2320 and Component Library 2330, all information required by Server I.H.S. 2310 to complete the data collection requirements of HEC Information sheet 2302, Server I.H.S. 2310 prepares HEC Report Card and Evaluation 2370 for distribution to Remote I.H.S. 2306, etc.

Once changes are implemented by building stewards a revised HEC Survey is created to establish a new HEC-SF & HEC-BE per FIG. 1 Method 100 Steps 126 & 128. For example, FIG. 9 Method 900 calculates new HEC variables reflecting the effect of changes and modifications to the structure. Step 940 illustrates a pre-change HEC-BE variable for a structure being modified. Step 930 depicts the change in HEC-BE variable due to the replacement of the subject property's space heater. FIG. 11 illustrates the structure's annual pre-HEC-BE was 2.888 BTU's/SF/HR prior to the replacement of the space heater. The Post-mod recalculated HEC Survey depicts the HEC-BE variable decreasing to 2.743 BTUs/SF/HR after the replacement of the furnace (Step 930). This Post-mod HEC-BE per Step 930 depicts a reduction in Historical Energy Consumption (HEC) of 5.3% due to the space heater's replacement.

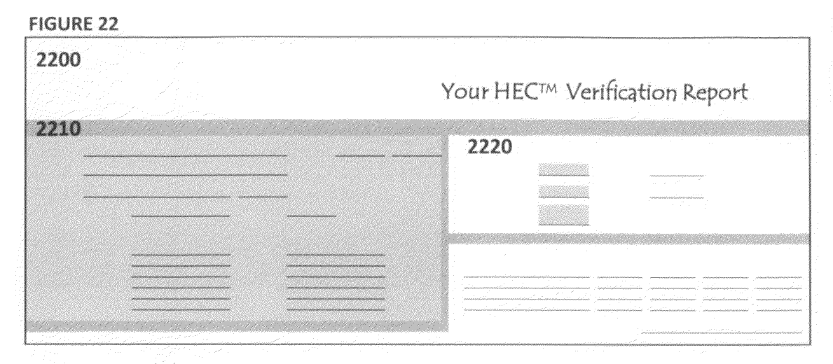

Further, once the new HEC variables are established, Server I.H.S. prepares a modified/recalculated HEC Verification Report per FIG. 22 Method 2200. FIG. 22 documents in Step 2210, the 2212 Pre-mod & the 2214 Post-mod HEC-SF and expresses the change in HEC variables as a percentage of the Pre-mod HEC per Step 2216. This section of the report concludes with Step 2230 summing the cumulative effects to Historical Energy Consumption (HEC) of all changes newly incorporated in the structure. The report FIG. 22 provides objective verification of energy consumption changes for purposes of permitting, tax credits, rebates, and reports to governmental officials, building professionals and building stewards/users. All records of recalculation of HEC ratings per modifications are sent to Server I.H.S. 750 by Remote I.H.S. 710 for archiving in Database 760 per FIG. 20 Method 2000.

In the best mode contemplated by the inventors, the HEC System offers alternative modes of beneficial analysis.

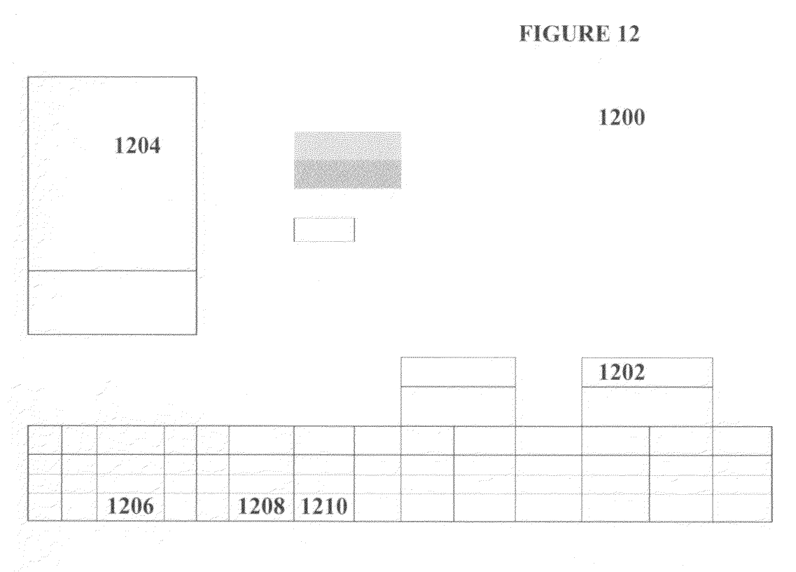

In one mode, FIG. 12 Method 1200 depicts an abbreviated method of the Historical Energy Consumption (HEC) Survey to be used for quick verification of annual energy consumption performance. In this abbreviated form the HEC-SF, calculated on an annual period, Step 1202, is used to establish historical energy performance. In this mode, the heated square footage of the structure, Step 1204, is provided by the building steward. The total annual energy consumption is collected (per FIG. 3 Method 300 and FIG. 4 Method 400) from all fuels is converted to BTU's and using Method 1200 Steps 1206, 1208 & 1210. The total BTU's consumed by the structure for the year, Step 1210, are then divided by the stated heated square footage (Step 1204). The resultant is divided by 8,760, the number of hours in a year, to complete the calculation of the HEC-SF, Step 1202. The Step 1202 HEC-SF is expressed in BTU's/SF/HR. This variable can be quickly calculated in successive years to verify changes in energy performance due to modifications of the structure, changes in owner behavior, changes in building performance due to environmental conditions, and to satisfy requirements to verify the efficacy of other building energy rating systems for building stewards, permitting entities, rebate programs and tax credit programs.

Further, another benefit provided by the HEC System, defects in construction relating to energy consumption patterns can be identified in a subject structure. For example, FIG. 9 Method 900 depicts a HEC Survey performed on a structure in a subdivision that underwent a fuel conversion from propane gas to natural gas. Steps 950 & 960 in FIG. 13 demonstrate a rise in BTU consumption, after conversion, of 262% in one month. When compared to the historic consumption for the identical monthly periods (see Steps 970 & 980), it is noted this is a disproportion spike in energy use based on historic utility records, readily discernible by those educated in the art. Per FIG. 21 Method 2100, remote I.H.S. 2130 sends the HEC Survey that is generated for the subject structure depicting this rise in energy consumption to Server I.H.S. 2140. The server sends the survey in complete and fractured forms to HEC Database 2150. Server I.H.S. 2140 recognizes the disparate energy consumption and issues HEC Report Card & Evaluation, FIG. 8 Method 800. Server I.H.S. provides information suggesting the existence of a gas leak at the subject structure per Steps 860, 862 & 864. Step 864 states the anticipated energy savings if corrected action is taken to repair the leak.

What is claimed is:

1. An objective, transparent, scientifically-based, computerized method that provides a method of collecting, measuring, analyzing and defining the energy consumption in built structures of all construction types and sizes, located in any climate zone, using any fuel type, comprising the steps of: receiving utility use data for the building being studied;
receiving and processing field survey data regarding the building being studied;
calculating the as-built heated square footage of the structure; calculating the area of the heated building envelope of the structure; calculating the total energy consumption of the building being studied; expressing the buildings energy consumption by square foot of heated area and by square foot of heated building envelope.

2. The method of claim 1, further comprising the step of aggregation of utility use data and the aggregation of data concerning additional fuels consumed for the functioning of the building (i.e. Wood pellets, cord wood, Renewable Energy sources, etc.).

3. The method of claim 1, further comprising the step of inclusion of a baseline variable called the Historical Energy Consumption (HEC) rating which aids in the analysis and comparison of physical modifications to a structure and behavioral modifications by its occupants;

4. The method of claim 3, further comprising the step of: obtaining the Historic Energy Consumption variable, a measurement of the buildings actual energy consumption, expressed using British Thermal Units (BTUs).

5. The method of claim 3, further comprising the step of expressing the Historic Energy Consumption variable in two forms; HEC-SF which expresses the variable in BTU's consumed per square foot of heated area per hour, and the HEC-BE which expresses the variable in BTU's consumed per square foot of heated building envelope.

6. The method of claim 1, further comprising the step of including a baseline variable of the heated square footage of the building envelope over the heated floor square footage of the building (i.e. BE/SF), which aids in the analysis of structural and behavioral modifications.

7. A computerized system comprising: multiple, remote information handling systems (IHS's) for receiving, via user input, data associated with a Historic Energy Consumption inspection and exporting this data via the internet to a network (system server IHS);
comprising a Central Processing Unit (CPU) and a storage device coupled to the CPU containing control files , an interactive database, and having information stored wherein for configuring the CPU to: receive utility use data for the building and collected Historic Energy Consumption survey data.

8. A computerized method comprising the steps of: calculating; analyzing; comparing; and archiving; the data collected in the HEC survey; concerning each specific structure; in a Historical Energy Consumption Database; wherein collected data is analyzed by the second IHS and based on the results of the analysis states facts and makes recommendations concerning decreasing the energy consumption of the structure and its occupants; whereby energy consumption targets and goals can be established and realized.

9. The method of claim 8, further comprising the step of assembling of processed field inspection data in report form, on the spreadsheet “What's Your HEC?” Information Sheet”.

10. The method of claim 8, further comprising the step of calculating a baseline variable called the Historical Energy Consumption (HEC) rating.

11. The method of claim 8, further comprising the step of calculating the Historic Energy Consumption variable in two forms; HEC-SF which expresses the variable in BTU's consumed per square foot of heated area per hour, and the HEC-BE which expresses the variable in BTU's consumed per square foot of heated building envelope.

12. The method of claim 8, further comprising the step of: creating accurate forecasts of energy consumption savings associated with specific modifications to a structure based upon scientific modeling against a database of comparable structures and their historical Historic Energy Consumption variables: i.e. identifies performance gaps based upon comparison of historical energy consumption patterns of similar structures.

13. The method of claim 8, further comprising the step of: creating an identification and quantification of energy consumed for the specific functions of lighting, space heating and cooling, water heating, and appliance functioning by analyzing the historical energy consumption patterns of the structure.

14. The method of claim 8, further comprising the step of generating a “Historic Energy Consumption Inspection Report Card and Evaluation” that draws comparisons and states conclusions drawn from the Historic Energy Consumption Database analysis of the structure.

15. The method of claim 8, further comprising the step of: developing an evolving, intelligent database that calculates and recommends best mode cost to value improvements to be made to a structure based upon established energy consumption or cost to construct goals.

16. The method of claim 8, further comprising the step of: tracking of any structures energy consumption before, and after specific modifications, and the expression of that consumption in the form of a HEC variable and the Percentage Change in its historical energy consumption performance (HEC-SF, or HEC-BE).

17. The method of claim 8, further comprising the step of tracking of any structures energy consumption and comparing that consumption to the consumption of structures of similar construction type and climate zone to study baseline historical energy consumption patterns.

18. The method of claim 8, further comprising the step of: developing an evolving, intelligent database that allows for the evaluation of future construction materials and techniques as they develop.

19. The method of claim 8, further comprising the step of developing an analysis of “best mode” distinctions concerning plan form, orientation, envelope configuration, mechanical and electrical systems, and construction methods and detailing, etc.

20. The method of claim 8, further comprising the step of creating the ability to test the accuracy of other building energy rating systems.
